(19) United States
(12) Patent Application Publication
(10) Pub. No.: US 2022/0373149 A1
(43) Pub. Date: Nov. 24, 2022

(54) VEHICLE LIGHTING

(71) Applicant: Ichikoh Industries, Ltd., Isehara-shi (JP)

(72) Inventor: Yasuhiro OKUBO, Isehara-shi (JP)

(73) Assignee: Ichikoh Industries, Ltd., Isehara-shi (JP)

(21) Appl. No.: 17/770,850

(22) PCT Filed: Oct. 21, 2020
(86) PCT No.: PCT/JP2020/039587

§ 371 Date: Apr. 21, 2022

(30) Foreign Application Priority Data
Oct. 25, 2019 (JP) 2019-194001

(51) Int. Cl. F21S 41/265; F21S 41/143

(52) U.S. Cl. CPC F21S 41/265; F21S 41/143; F21Y 2115/10

(57) ABSTRACT

A vehicular lamp includes a light source and a projection lens to form an irradiation pattern. The irradiation pattern includes a main instruction symbol and one or more sub instruction symbols. The main instruction symbol is more emphasized than the sub instruction symbols. In the projection lens, an incidence surface is a continuous surface. The projection lens includes an upper lens part that forms the main instruction symbol and a lower lens part that forms the sub instruction symbols. In the projection lens, at least both end parts in a horizontal direction of an upper emission surface allowing emission of light from the light source in the upper lens part protrude further to a projecting side than both end parts in the horizontal direction of a lower emission surface allowing emission of the light from the light source in the lower lens part.

### TECHNICAL FIELD

The present disclosure relates to a vehicular lamp.

### BACKGROUND ART

There are disclosed vehicular lamps that project an irradiation pattern on a road surface in the surrounding area of a vehicle and form a predetermined irradiation pattern in the surrounding area of the vehicle to convey a certain intention to a person in the surrounding area (see, for example, PTL 1).

This vehicular lamp blocks part of the light emitted from a light source with a slit plate and then projects it through a projection lens to improve the degree of recognition of the irradiation pattern formed on the road surface.

### CITATION LIST

### Patent Literature

PTL 1: Japanese Unexamined Patent Application Publication No. 2018-98066

### SUMMARY OF THE INVENTION

### Problems to be Solved by the Invention

However, the above-described vehicular lamp makes it difficult to efficiently use the light from the light source because part of the light from the light source is blocked with the slit plate and also causes an increase in the number of parts because the light source, the slit plate, and the projection lens are used to improve the degree of recognition of the irradiation pattern.

The present disclosure has been made in consideration of the above-described circumstances and has an object to provide a vehicular lamp that forms an irradiation pattern with which a certain intention may be conveyed to a person in the surrounding area, while the light from a light source is efficiently used and the number of parts is reduced.

### Means for Solving the Problem

A vehicular lamp according to the present disclosure includes a light source and a projection lens that projects a light emitted from the light source to form an irradiation pattern, wherein the irradiation pattern includes a main instruction symbol formed on a front side in a projection direction and one or more sub instruction symbols formed further on a back side than the main instruction symbol in the projection direction, the main instruction symbol is more emphasized than the sub instruction symbols, and the projection lens includes an upper lens part that forms the main instruction symbol and a lower lens part that forms the sub instruction symbols.

### Effect of the Invention

With the vehicular lamp according to the present disclosure, a certain intention may be conveyed to a person in the surrounding area while the light from the light source is efficiently used and the number of parts is reduced.

### BRIEF DESCRIPTION OF THE DRAWINGS

FIG. 1 is an explanatory diagram illustrating the state where a vehicular lamp according to a first embodiment of the present disclosure is mounted on a vehicle to form an irradiation pattern.

FIG. 2 is an explanatory diagram illustrating a configuration of the vehicular lamp according to the first embodiment.

FIG. 3 is an explanatory diagram illustrating the irradiation pattern projected onto a screen by the vehicular lamp.

FIG. 4 is an explanatory diagram illustrating the state where a light travels through an upper-end vicinity position, an intermediate position, and an optical-axis vicinity position of an upper lens part of a projection lens and the state where a light travels through an optical-axis vicinity position, an intermediate position, and a lower-end vicinity position of a lower lens part of the projection lens in longitudinal cross-section including an optical axis in the vehicular lamp.

FIG. 5 is an explanatory diagram illustrating the state of optical settings of the projection lens and illustrating, on the screen, the relation between outline positions of a main instruction symbol and a sub instruction symbol and a plurality of light distribution images with the light passing through the upper-end vicinity position of the upper lens part.

FIG. 6 is an explanatory diagram similar to FIG. 5, illustrating, on the screen, the relation between the outline positions of the main instruction symbol and the sub instruction symbol and the light distribution images with the light passing through the intermediate position of the upper lens part.

FIG. 7 is an explanatory diagram similar to FIG. 5, illustrating, on the screen, the relation between the outline positions of the main instruction symbol and the sub instruction symbol and the light distribution images with the light passing through the optical-axis vicinity position of the upper lens part.

FIG. 8 is an explanatory diagram similar to FIG. 5, illustrating, on the screen, the relation between the outline positions of the main instruction symbol and the sub instruction symbol and the light distribution images with the light passing through the optical-axis vicinity position of the lower lens part.

FIG. 9 is an explanatory diagram similar to FIG. 5, illustrating, on the screen, the relation between the outline positions of the main instruction symbol and the sub instruction symbol and the light distribution images with the light passing through the intermediate position of the lower lens part.

FIG. 10 is an explanatory diagram similar to FIG. 5, illustrating, on the screen, the relation between the outline positions of the main instruction symbol and the sub instruction symbol and the light distribution images with the light passing through the lower-end vicinity position of the lower lens part.

FIG. 11 is an explanatory diagram illustrating the state where the light travels through the upper lens part of the projection lens in transverse cross-section parallel to the optical axis in the vehicular lamp.

FIG. 12 is an explanatory diagram illustrating the state where the light travels through the lower lens part of the projection lens in transverse cross-section parallel to the optical axis in the vehicular lamp.

FIG. 13 is an explanatory diagram illustrating a usage example that is an example of the irradiation pattern formed by the vehicular lamp.

FIG. 14 is an explanatory diagram illustrating the state where the vehicular lamp according to a second embodiment of the present disclosure is mounted on the vehicle to form the irradiation pattern.

FIG. 15 is an explanatory diagram illustrating a configuration of the vehicular lamp according to the second embodiment.

### MODE FOR CARRYING OUT THE INVENTION

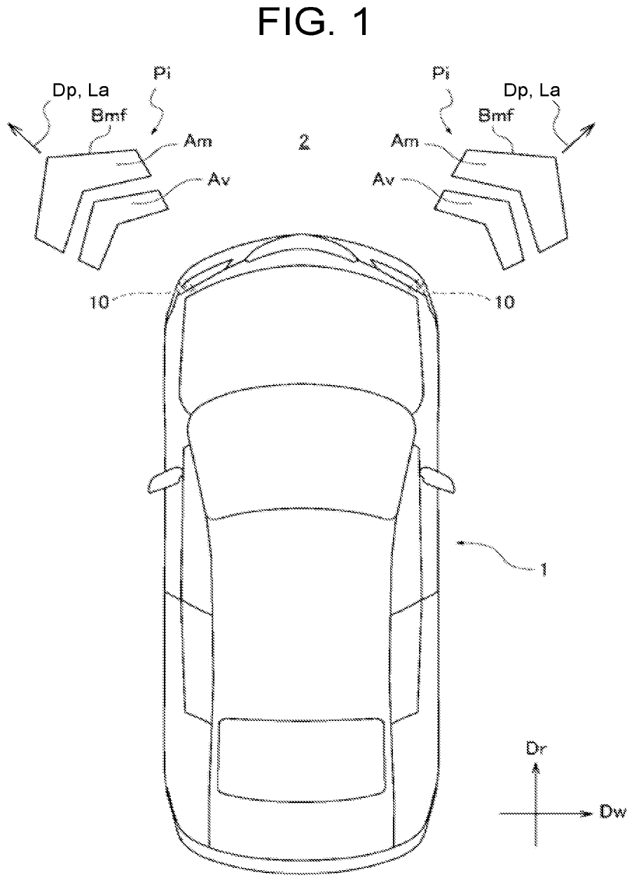

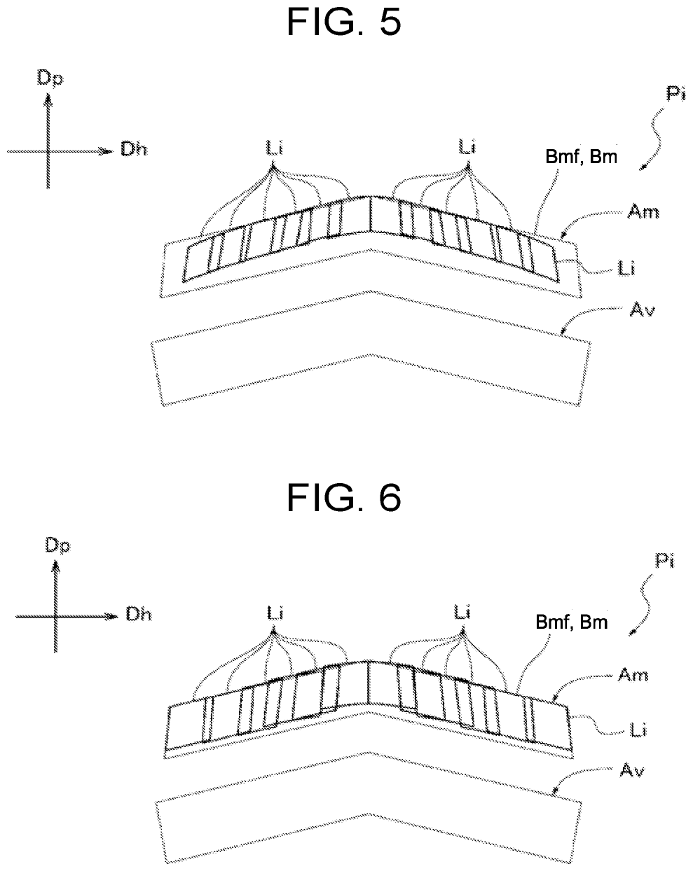

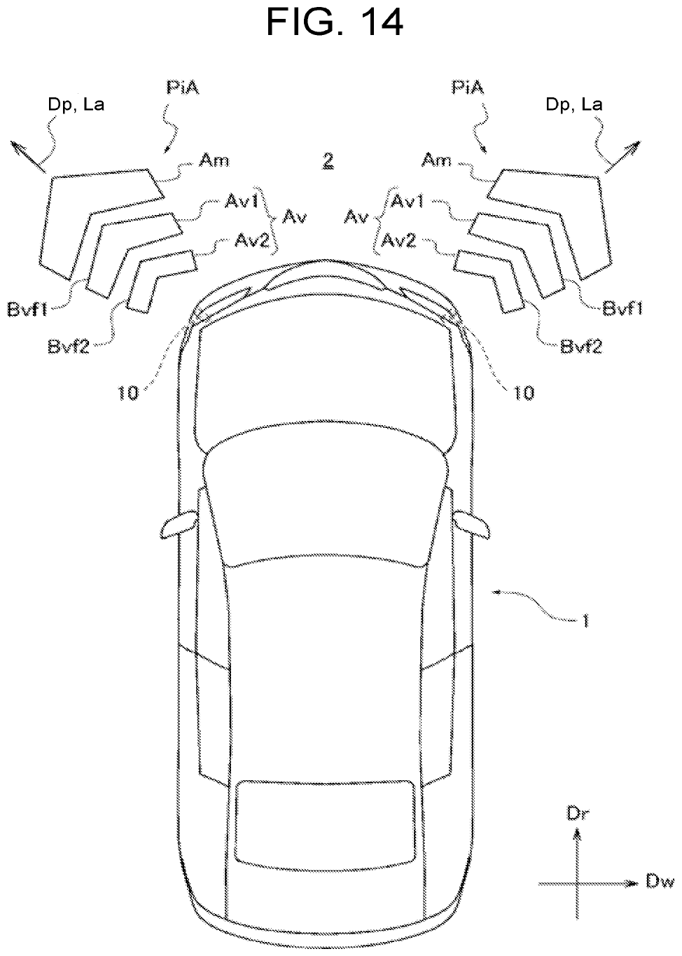

Embodiments of a vehicular lamp 10, which is an example of a vehicular lamp according to the present disclosure, will be described below with reference to the drawings. Further, in FIGS. 1 and 14, in order to facilitate understanding of the state where the vehicular lamp 10 is provided, the size of the vehicular lamp 10 with respect to the vehicle 1 is illustrated in an enlarged manner, but does not necessarily correspond to the actual state. Furthermore, in FIGS. 5 to 10, in order to facilitate understanding of the state where a main instruction symbol Am and a sub instruction symbol Av of an irradiation pattern Pi is formed by each light distribution image Li, only the selected light distribution images Li are illustrated and do not necessarily correspond to the actual state.

### First Embodiment

The vehicular lamp 10 according to a first embodiment, which is an embodiment of a vehicular lamp according to the present disclosure, will be described using FIGS. 1 to 13. As illustrated in FIG. 1, the vehicular lamp 10 according to the first embodiment is used as a lamp for the vehicle 1 such as an automobile to form the irradiation pattern Pi on a road surface 2 in the surrounding area of the vehicle 1, separately from a headlight provided in the vehicle 1. Here, the surrounding area of the vehicle 1 necessarily includes a proximity area that is closer to the vehicle 1 than a headlight area illuminated by the headlight provided in the vehicle 1 and may partially include the headlight area. The vehicular lamp 10 is provided in a lamp chamber of the headlight, or the like, of the vehicle 1, a door mirror, a side surface of a vehicle body, etc., and according to the first embodiment, is provided in lamp chambers on the right and left sides of a front part of the vehicle 1. The lamp chamber is formed such that an open front end of a lamp housing is covered by an outer lens. The vehicular lamp 10 is provided such that an optical axis La is tilted with respect to the road surface 2. This is because the lamp chamber is positioned at a higher position than the road surface 2.

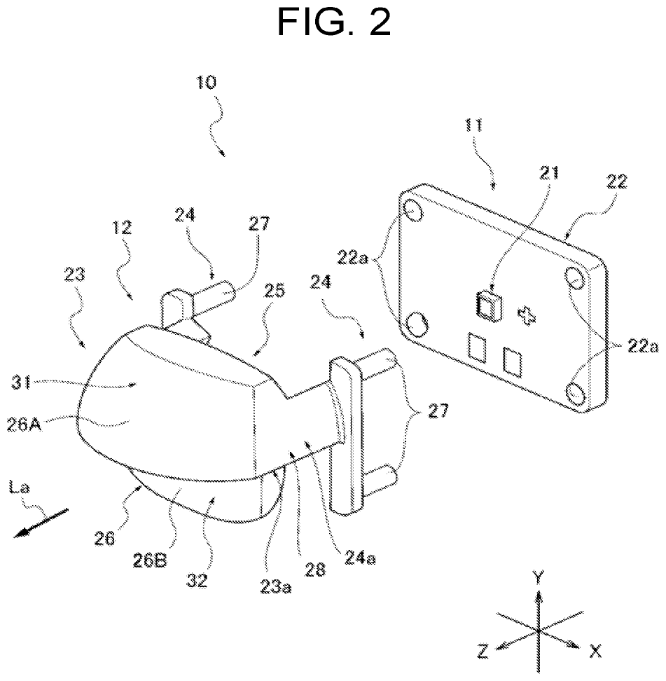

In the following description, as illustrated in FIG. 1, the direction in which the vehicle 1 travels on the road surface 2 in the surrounding area of the vehicle 1 is a traveling direction (Dr in the drawing) and the direction perpendicular to the traveling direction is a width direction (Dw in the drawing). Furthermore, as illustrated in FIG. 2, in the vehicular lamp 10, the direction in which the optical axis La extends, which is the direction in which the light is emitted, is an optical axis direction (Z in the drawing), the vertical direction when the optical axis direction extends along a horizontal plane is an up-down direction (Y in the drawing), and the direction (horizontal direction) perpendicular to the optical axis direction and the up-down direction is a right-left direction (X in the drawing).

The vehicular lamp 10 has a light source unit 11 and a projection lens 12 assembled therein to constitute a direct projection type road-surface projection unit. The vehicular lamp 10 is accommodated in an appropriate housing and provided in the vehicle 1 with the light source unit 11 and the projection lens 12 assembled therein.

In the light source unit 11, a light source 21 is mounted on a substrate 22. The light source 21 includes a light emitting device such as an LED (Light Emitting Diode) and is provided such that a radiation central axis conforms with the optical axis La. According to the first embodiment, the light source 21 emits amber light (the one that is substantially close to monochromatic light in amber having the largest peak in a wavelength band of the amber in a graph having the light intensity as the vertical axis and the wavelength as the horizontal axis) with a Lambertian distribution having the radiation central axis as a center. In the light source 21, a light emitting unit (a light emitting area) has a rectangular shape when viewed in the optical axis direction. Further, the color (wavelength band), the distribution mode, the number of colors (the number of peaks in the above-described graph), etc., of the radiation light may be set as appropriate, and the light source 21 is not limited to the configuration according to the first embodiment.

The substrate 22 supplies electric power from a lighting control circuit as appropriate to turn on the light source 21. The substrate 22 is formed in a plate-like shape and has a square shape when viewed in the optical axis direction. The substrate 22 includes mounting holes 22a on four corners.

The substrate 22 uses aluminum according to the first embodiment and also functions as a heat sink member to dissipate heat generated by the mounted light source 21 to outside. Further, the substrate 22 may include a plurality of radiator fins as appropriate. Moreover, the light source unit 11 may be configured to include a different radiator member on the substrate 22. The light emitted from the light source 21 of the light source unit 11 is projected onto the road surface 2 by the projection lens 12.

The projection lens 12 includes a lens main body part 23, which is a convex lens having a square shape when viewed in the optical axis direction, and mounting parts 24 provided on both sides. Further, the square shape may be a rectangular shape or may be curved on each side as long as there are four corner parts (including those chamfered into a sphere, or the like). The lens main body part 23 projects the light from the light source 21 while shaping it to form the irradiation pattern Pi on a projection target (the road surface 2 according to the first embodiment) and has a continuous surface as an incidence surface 25. The continuous surface refers to a single free-form surface, i.e., a surface having a smoothly varying curvature without steps, and at least a function of class C1. Optical settings including the shape, and the like, of the incidence surface 25 and an emission surface 26 of the lens main body part 23 (the projection lens 12) will be described below. The projection lens 12 has a lens axis extending in the optical axis direction. The lens axis is an axis that is the optical center in the lens main body part 23.

The mounting parts 24 in a pair are provided on both side parts of the lens main body part 23 in the right-left direction and each protrude to the back side (the light source unit 11 side) in the optical axis direction. Each of the mounting parts 24 includes mounting protrusions 27 at end parts thereof in the up-down direction. Each of the mounting protrusions 27 has a cylindrical shape protruding to the back side in the optical axis direction and may be fitted into a mounting hole 22a of the substrate 22. In the mounting part 24, each of the mounting protrusions 27 is fitted into the corresponding mounting hole 22a, and thus the lens axis of the lens main body part 23 conforms with the radiation central axis of the light source 21 of the light source unit 11, and they serve as the optical axis La in the vehicular lamp 10.

The projection lens 12 includes scattering parts 28 on end faces in the right-left direction. The end faces in the right-left direction include two side surfaces 23a of the lens main body part 23 and outer side surfaces 24a of the respective mounting parts 24. The scattering part 28 scatters (causes traveling in various directions) the light guided into the projection lens 12 and emitted from the two side surfaces 23a and the outer side surfaces 24a and is formed by applying for example emboss processing or blasting processing to each of the side surfaces (23a, 24a). Therefore, in the vehicular lamp 10, even when the light from the light source 21 is guided into the projection lens 12 and is emitted from the two side surfaces 23a of the lens main body part 23 and the outer side surfaces 24a of the respective mounting parts 24, the light may be scattered by the scattering part 28 and may be prevented from being leakage light that illuminates the irradiation pattern Pi and unintended areas in the surrounding area.

As illustrated in FIG. 1, the vehicular lamp 10 forms the plane-symmetrical irradiation pattern Pi with respect to a plane perpendicular to the width direction of the vehicle 1 on the right and left of the vehicle 1. When the direction in which the optical axis La of the vehicular lamp 10 extends on the projection target (the road surface 2) is a projection direction Dp (the side away from the vehicle 1 is the front side) and the direction perpendicular to the projection direction Dp is a projection transverse direction Dh (the center thereof is located on the optical axis La), the irradiation pattern Pi includes the main instruction symbol Am and the sub instruction symbol Av that are positioned side-by-side in the projection direction Dp. The main instruction symbol Am and the sub instruction symbol Av indicate the front side in the projection direction Dp and, according to the first embodiment, resemble an arrow joining two straight lines that protrude to the front side, bend, and also connect to each other. The irradiation pattern Pi may be set by adjusting the irradiation pattern Pi on a screen in consideration of the distance and angle from the vehicular lamp 10 mounted on the vehicle 1 to the road surface 2.

In the irradiation pattern Pi, the main instruction symbol Am is more emphasized than the sub instruction symbol Av, that is, the sub instruction symbol Av and the main instruction symbol Am are emphasized with the same degree, or the main instruction symbol Am is more emphasized than the sub instruction symbol Av. This emphasis causes the main instruction symbol Am to be more noticeable than the sub instruction symbol Av on the projection target by making the main instruction symbol Am larger than the sub instruction symbol Av or making a bright-dark boundary Bm of the main instruction symbol Am clearer than a bright-dark boundary Bv of the sub instruction symbol Av. The difference in size may be made by changing the thickness of the straight lines forming the two instruction symbols (Am, Av), changing the length of the two straight lines, or changing both of them together. Further, the bright-dark boundary Bm may be clear by collecting the light inside at least part thereof to emphasize the difference between bright and dark.

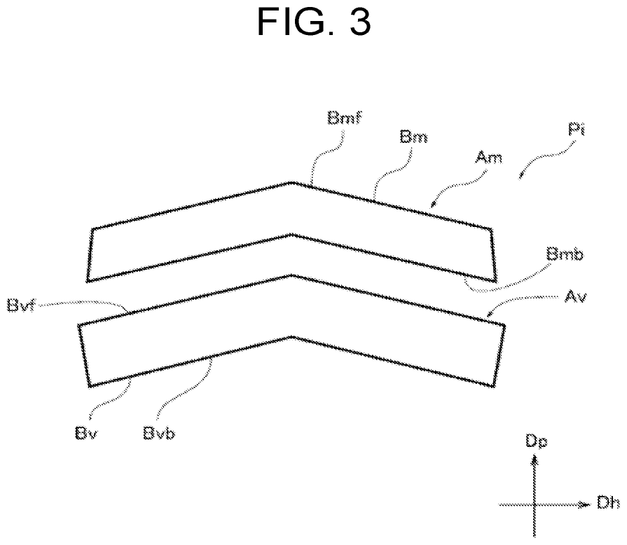

Next, the optical settings of the lens main body part 23 (the projection lens 12) will be described by using FIGS. 3 to 10. FIG. 3 illustrates the irradiation pattern Pi that is formed on the screen, which is arranged perpendicular to the optical axis La, and that has a different shape from the one projected on the road surface 2 (see FIG. 1). In FIG. 3, the up-down direction in the front view corresponds to the projection direction Dp on the road surface 2 (the upper side is the front side), and the right-left direction corresponds to the projection transverse direction Dh on the road surface 2. As illustrated in FIG. 3, the two instruction symbols (Am, Av) of the irradiation pattern Pi have a shape (contour line) such that, on the screen, two straight lines having a predetermined width in the projection direction Dp are connected at the central position (on the line including the optical axis La and extending in the projection direction Dp) in the projection transverse direction Dh. The two instruction symbols (Am, Av) are inclined toward the front side in the projection direction Dp as the two straight lines are close to the central position in the projection transverse direction Dh. In the irradiation pattern Pi, the sub instruction symbol Av is slightly larger than the main instruction symbol Am on the screen, but when projected on the road surface 2, the main instruction symbol Am is larger than the sub instruction symbol Av as illustrated in FIG. 1 due to the inclination of the optical axis La with respect to the road surface 2. Furthermore, the lens main body part 23 is optically set to form the irradiation pattern Pi on the screen.

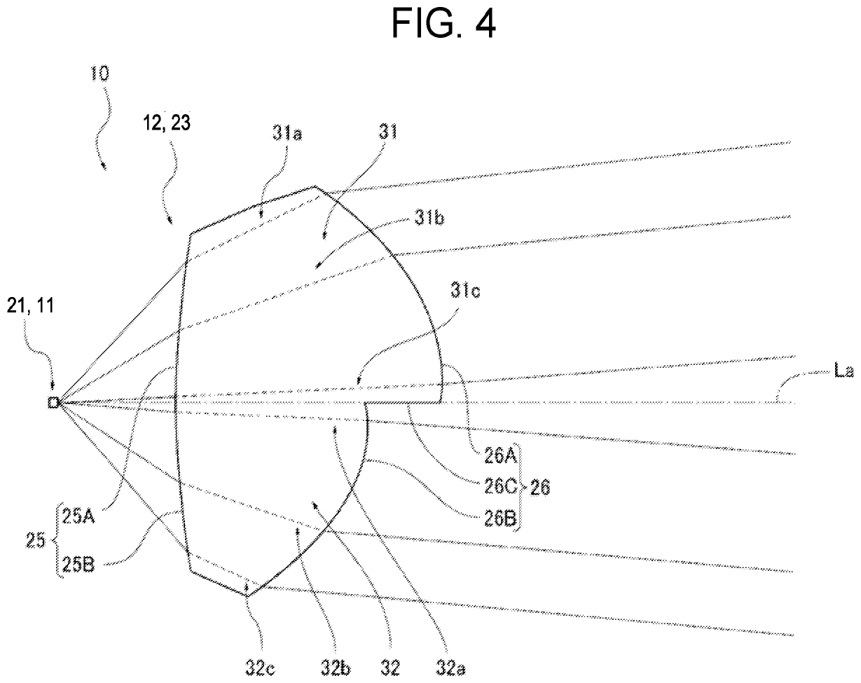

As illustrated in FIG. 4, the lens main body part 23 includes an upper lens part 31, which is located on the upper side, and a lower lens part 32, which is located on the lower side, with the optical axis La as a center. Specifically, the optical settings are individually made such that the upper lens part 31 forms the main instruction symbol Am at a position farthest from the vehicular lamp 10 on the front side in the projection direction Dp and the lower lens part 32 forms the sub instruction symbol Av further on the back side (near side) than the main instruction symbol Am in the projection direction Dp.

As one of the optical settings of the lens main body part 23, the focal length of the upper lens part 31 is larger than the focal length of the lower lens part 32. This allows the lens main body part 23 to properly project the main instruction symbol Am at a position away from the vehicular lamp 10 and also properly project the sub instruction symbol Av at a closer position than the main instruction symbol Am with the light from the single light source unit 11 (the light source 21) on the road surface 2. In the lens main body part 23, an upper emission surface 26A, which is the emission surface 26 of the upper lens part 31, is displaced further to the front side in the optical axis direction than a lower emission surface 26B, which is the emission surface 26 of the lower lens part 32. In the lens main body part 23, the upper emission surface 26A is displaced further to the front side in the optical axis direction than the lower emission surface 26B, and thus the focal length of the upper lens part 31 is larger than the focal length of the lower lens part 32. Accordingly, the lens main body part 23 includes a stepped surface 26C that is provided between the upper emission surface 26A and the lower emission surface 26B, is perpendicular to the up-down direction, and includes the optical axis La.

For the description of the optical settings, FIG. 4 illustrates the state where the light travels through an upper-end vicinity position 31a, an intermediate position 31b, and an optical-axis vicinity position 31c of the upper lens part 31 and the state where the light travels through an optical-axis vicinity position 32a, an intermediate position 32b, and a lower end vicinity position 32c of the lower lens part 32 in longitudinal cross-section including the optical axis direction and the up-down direction, i.e., longitudinal cross-section perpendicular to the width direction. As illustrated in FIGS. 5 to 10, the upper lens part 31 and the lower lens part 32 project the light from the light source 21 in accordance with the optical settings and thus superimposes the light distribution images Li of the light source 21 on the screen as appropriate to form the main instruction symbol Am and the sub instruction symbol Av. Each of the light distribution images Li basically has a square shape due to the projection of the light source 21, but the position and shape formed change as appropriate in accordance with the optical settings of the upper lens part 31 and the lower lens part 32 at the position through which the light passes.

Here, when formed by the upper lens part 31, the shape of each of the light distribution images Li tends to change such that the side on the front side in the projection direction Dp becomes shorter than the side on the back side (See FIGS. 5 to 7), and when formed by the lower lens part 32, the shape tends to change such that the side on the front side in the projection direction Dp becomes longer than the side on the back side (see FIGS. 8 to 10). Furthermore, when the light distribution images Li are positioned side-by-side, which are formed with the light passing through different positions in a rotation direction around the optical axis La while the distance from the optical axis La is the same, the row formed by the upper lens part 31 tends to form an arc protruding to the front side in the projection direction Dp and the row formed by the lower lens part 32 tends to form an arc protruding to the back side in the projection direction Dp. Furthermore, when formed by the upper lens part 31, each of the light distribution images Li on the left side from the central position in the projection transverse direction Dh inclines downward to the left (the two sides in the up-down direction incline downward to the left) and, on the right side from the central position, incline downward to the right (see FIGS. 5 to 7). Further, when formed by the lower lens part 32, each of the light distribution images Li on the left side from the central position in the projection transverse direction Dh inclines upward to the left and, on the right side from the central position, inclines upward to the right (see FIGS. 8 to 10). That is, each of the light distribution images Li tends to incline and distort along a tangent of the above-described arc. It is considered that these are caused by the fact that the lens main body part 23 basically has a point-symmetrical relation with the optical axis La as a center in terms of optics. The upper lens part 31 and the lower lens part 32 efficiently use the forms of changes of the light distribution images Li to form the main instruction symbol Am and the sub instruction symbol Av.

For the upper lens part 31 and the lower lens part 32, the position of the light distribution image Li formed on the screen in the projection direction Dp is set by primarily adjusting the shape of the emission surface 26 (the upper emission surface 26A, the lower emission surface 26B), and the shape of each of the light distribution images Li and the position thereof in the projection transverse direction Dh are set by primarily adjusting the shape of the incidence surface 25 (the upper incidence surface 25A, the lower incidence surface 25B). Therefore, for the upper lens part 31 and the lower lens part 32, as one of the optical settings, the curvatures (surface shapes) of the upper emission surface 26A and the lower emission surface 26B are primarily adjusted at each position to make the optical settings in longitudinal cross-section and transverse cross-section. The upper emission surface 26A and the lower emission surface 26B are optically set by gradually changing the curvature to each have a single smooth surface without steps. This setting will be described by using the positions where the light distribution images Li are formed by the upper-end vicinity position 31a, the intermediate position 31b, and the optical-axis vicinity position 31c of the upper lens part 31 and the positions where the light distribution images Li are formed by the optical-axis vicinity position 32a, the intermediate position 32b, and the lower-end vicinity position 32c of the lower lens part 32, as illustrated in FIGS. 5 to 10. The position where each of the light distribution images Li is formed may be set as appropriate by adjusting the curvatures of the upper emission surface 26A and the lower emission surface 26B at the corresponding area.

First, the upper lens part 31 will be described. The upper-end vicinity position 31a is in the vicinity of the upper end of the optically effective area of the upper lens part 31 to collect the light and thus emphasize a main front boundary Bmf (an upper outline on the front view in FIG. 5) of the main instruction symbol Am on the front side in the projection direction Dp while forming the main instruction symbol Am. As illustrated in FIG. 5, the upper-end vicinity position 31a causes the formed light distribution images Li to have the size corresponding to part of the main instruction symbol Am in the projection direction Dp and to come close to the main front boundary Bmf. Thus, the upper-end vicinity position 31a causes each of the light distribution images Li to be projected within the main instruction symbol Am and causes an edge part of each of the light distribution images Li on the front side in the projection direction Dp to be aligned to form the main front boundary Bmf. As the light distribution images Li by the upper lens part 31 are distorted along the tangent of the arc with the optical axis La as a center, the inclination of the upper sides conforms with the inclination of the main front boundary Bmf, and thus they may be properly positioned side-by-side along the main front boundary Bmf. Accordingly, the upper-end vicinity position 31a emits the main instruction symbol Am and also collects the light at the main front boundary Bmf to obtain the clear difference in bright and dark between the main instruction symbol Am and the outer side thereof (the outer side of the irradiation pattern Pi) and obtain the sharp main front boundary Bmf.

The intermediate position 31b is in the vicinity of the middle of the optically effective area of the upper lens part 31 in the up-down direction to collect the light on the front side of the main instruction symbol Am in the projection direction Dp while forming the main instruction symbol Am. As illustrated in FIG. 6, the intermediate position 31b causes the formed light distribution images Li to have a size that is larger than that of the one formed by the upper-end vicinity position 31a and that corresponds to part of the main instruction symbol Am in the projection direction Dp and causes them to come close to the main front boundary Bmf. The intermediate position 31b projects the larger light distribution images Li than the light distribution images Li projected by the upper-end vicinity position 31a and thus may form the light distribution images Li up to the vicinity of both side ends of the main instruction symbol Am in the projection transverse direction Dh. Accordingly, the intermediate position 31b emits the main instruction symbol Am and collects the light at the main front boundary Bmf to obtain the clear difference in bright and dark between the main instruction symbol Am and the outer side thereof (the outer side of the irradiation pattern Pi) and obtain the sharp main front boundary Bmf while illuminating up to both side ends of the main instruction symbol Am in the projection transverse direction Dh.

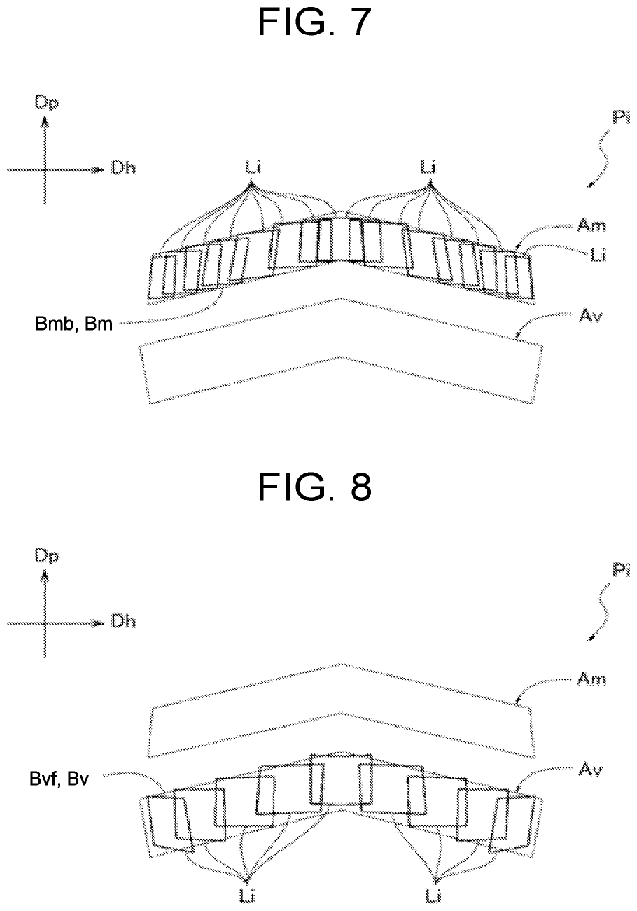

The optical-axis vicinity position 31c is in the vicinity of the optical axis La in the optically effective area of the upper lens part 31 to diffuse the light (group of rays) passing in the vicinity of the optical axis La (increase the interval from each other in the traveling direction) and thus form a main back boundary Bmb of the main instruction symbol Am on the back side in the projection direction Dp. As illustrated in FIG. 7, the optical-axis vicinity position 31c causes the light distribution images Li to have a size corresponding to the entire main instruction symbol Am in the projection direction Dp and causes them to come close to the main back boundary Bmb. The optical-axis vicinity position 31c projects the larger light distribution images Li than the light distribution images Li projected by the upper-end vicinity position 31a and the intermediate position 31b and thus may form the light distribution images Li up to both side ends of the main instruction symbol Am in the projection transverse direction Dh. Accordingly, the optical-axis vicinity position 31c emits the main instruction symbol Am and also collects the light at the main back boundary Bmb to obtain the clear difference in bright and dark between the main instruction symbol Am and the outer side thereof (the outer side of the irradiation pattern Pi) and also illuminate up to both side ends of the main instruction symbol Am in the projection transverse direction Dh.

As described above, when the light passing area is displaced from the upper-end vicinity position 31a to the optical-axis vicinity position 31c, the upper lens part 31 changes the formed light distribution images Li from the size corresponding to part of the main instruction symbol Am in the projection direction Dp to the size corresponding to the entire main instruction symbol Am. Furthermore, when the light passing area is displaced from the upper-end vicinity position 31a to the optical-axis vicinity position 31c, the upper lens part 31 changes the state of forming the upper side along the main front boundary Bmf to the state of forming the lower side along the main back boundary Bmb and also to the state of reaching both side ends of the main instruction symbol Am in the projection transverse direction Dh. Thus, the upper lens part 31 collects a large amount of light at the main front boundary Bmf for sharpness and also illuminates up to both side ends in the projection transverse direction Dh to form the main instruction symbol Am.

Next, the lower lens part 32 will be described. The optical-axis vicinity position 32a is in the vicinity of the optical axis La in the optically effective area of the lower lens part 32 to diffuse the light (group of rays) passing in the vicinity of the optical axis La and thus form the sub instruction symbol Av. As illustrated in FIG. 8, the optical-axis vicinity position 32a causes the formed light distribution images Li to have a size corresponding to the entire sub instruction symbol Av in the projection direction Dp and also causes them to come close to a sub front boundary Bvf on the front side in the projection direction Dp. As the projected light distribution images Li have a size corresponding to the entire sub instruction symbol Av in the projection direction Dp, the optical-axis vicinity position 32a allows the light distribution images Li to be formed substantially uniformly up to both side ends of the sub instruction symbol Av in the projection transverse direction Dh. Thus, the optical-axis vicinity position 32a forms the sub front boundary Bvf and also illuminates up to both side ends in the projection transverse direction Dh to form the sub instruction symbol Av with substantially uniform brightness.

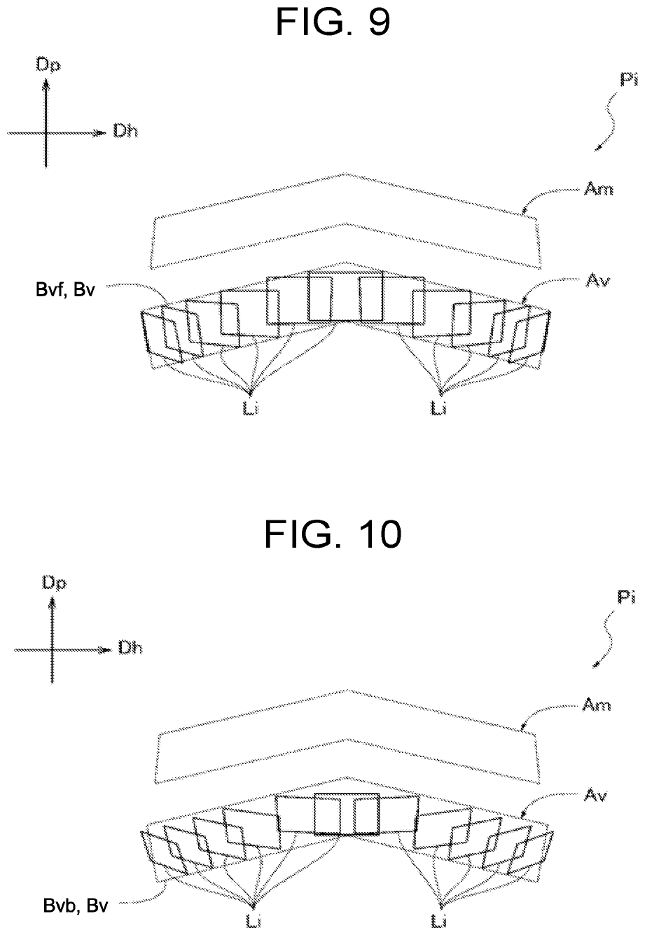

The intermediate position 32b is in the vicinity of the middle of the optically effective area of the lower lens part 32 in the up-down direction to collect the light on the front side of the sub instruction symbol Av in the projection direction Dp while forming the sub instruction symbol Av. As illustrated in FIG. 9, the intermediate position 32b causes the formed light distribution images Li to have a size that is smaller than that of the one formed by the optical-axis vicinity position 32a and that corresponds to part of the sub instruction symbol Av in the projection direction Dp and causes them to come close to the sub front boundary Bvf. Although the intermediate position 32b projects the smaller light distribution images Li than the light distribution images Li projected by the optical-axis vicinity position 32a, the light distribution images Li may be formed substantially uniformly up to the vicinity of both side ends of the sub instruction symbol Av in the projection transverse direction Dh. Thus, the intermediate position 32b forms the sub front boundary Bvf and also illuminates up to both side ends in the projection transverse direction Dh to form the sub instruction symbol Av with substantially uniform brightness.

The lower-end vicinity position 32c is in the vicinity of the lower end of the optically effective area of the lower lens part 32 to collect the light and thus form a sub back boundary Bvb (the lower side on the front view in FIG. 10) on the back side of the sub instruction symbol Av in the projection direction Dp. As illustrated in FIG. 10, the lower-end vicinity position 32c causes the formed light distribution images Li to have a size corresponding to part of the sub instruction symbol Av in the projection direction Dp and also causes them to come close to the sub back boundary Bvb. Although the lower-end vicinity position 32c projects the smaller light distribution images Li than the light distribution images Li projected by the intermediate position 32b, the light distribution images Li may be formed substantially uniformly up to the vicinity of both side ends of the sub instruction symbol Av in the projection transverse direction Dh. Thus, the lower-end vicinity position 32c forms the sub back boundary Bvb and also illuminates up to both side ends in the projection transverse direction Dh to form the sub instruction symbol Av with substantially uniform brightness.

As described above, even when the light passing area is displaced from the optical-axis vicinity position 32a to the lower-end vicinity position 32c, the lower lens part 32 diffuses each of the formed light distribution images Li, i.e., the light from the light source 21 in the projection transverse direction Dh, as compared to the upper lens part 31. Furthermore, when the light passing area is displaced from the optical-axis vicinity position 32a to the lower-end vicinity position 32c, the lower lens part 32 changes the state of formation along the sub front boundary Bvf to the state of formation along the sub back boundary Bvb. Therefore, the lower lens part 32 forms the sub instruction symbol Av with substantially uniform brightness.

Here, in the lens main body part 23, when the curvature of the upper emission surface 26A is adjusted in order to adjust the position of each of the light distribution images Li in the upper lens part 31, each of the light distribution images Li tends to come closer to the central position in the projection transverse direction Dh. Furthermore, in the lens main body part 23, when the curvature of the lower emission surface 26B is adjusted in order to adjust the position of each of the light distribution images Li described above in the lower lens part 32, each of the light distribution images Li tends to come close to the outer side (tends to move away from the central position) in the projection transverse direction Dh. Therefore, in the upper lens part 31 and the lower lens part 32, as one of the optical settings, the shape in longitudinal cross-section and the shape on transverse cross-section including the optical axis direction and the right-left direction, i.e., in transverse cross-section perpendicular to the up-down direction, are set for the incidence surface 25 (the upper incidence surface 25A, the lower incidence surface 25B), and thus each of the light distribution images Li is positioned as described above to assist in forming the main instruction symbol Am and the sub instruction symbol Av.

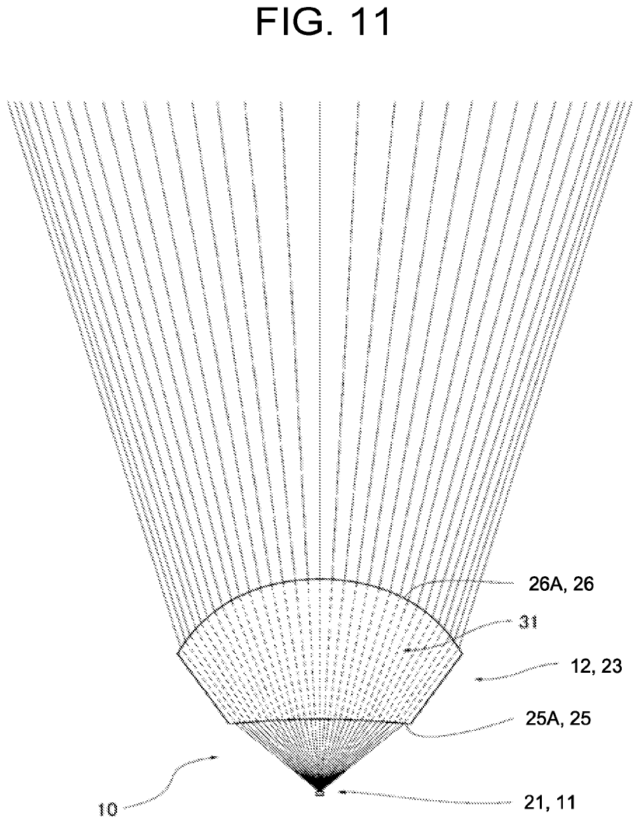

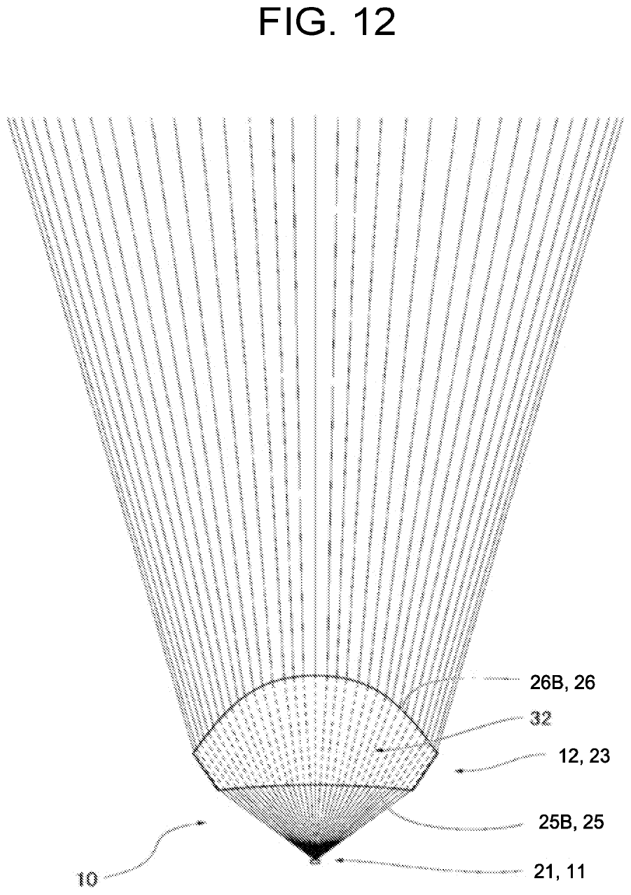

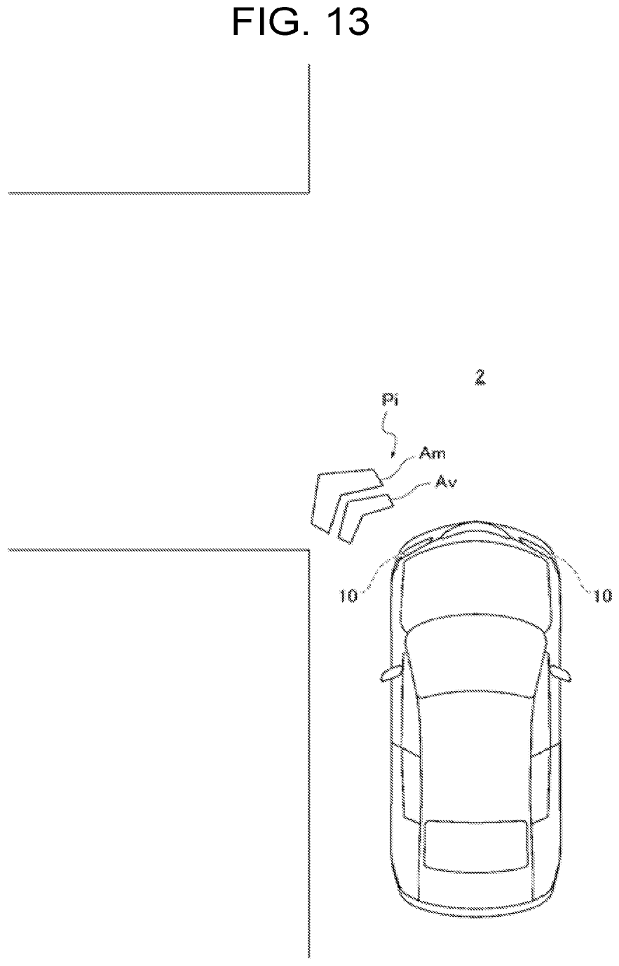

In the upper lens part 31 and the lower lens part 32, the upper incidence surface 25A and the lower incidence surface 25B are a convex surface, i.e., a curved surface protruding toward the light source 21 side (the back side in the optical axis direction) in longitudinal cross-section (see FIG. 4). Furthermore, in the upper lens part 31 and the lower lens part 32, the upper incidence surface 25A and the lower incidence surface 25B are a concave surface, i.e., a curved surface protruding toward the opposite side of the light source 21 (the front side in the optical axis direction) in transverse cross-section (see FIGS. 11 and 12). Moreover, in the upper lens part 31 and the lower lens part 32, the shapes of the upper incidence surface 25A and the lower incidence surface 25B in transverse cross-section are adjusted as appropriate as described below.

As illustrated in FIG. 11, the curvature of the upper incidence surface 25A is adjusted such that, with respect to the light from the light source 21 in transverse cross-section, the light (group of rays) passing in the vicinity of the optical axis La diffuses and the light (group of rays) passing at a position away from the optical axis La is substantially parallel. Specifically, in transverse cross-section, the upper lens part 31 diffuses the light in the vicinity of the optical axis La, where a Lambertian distribution is obtained and the light intensity is high, and also focuses the light at a position from the vicinity of the optical axis La toward outside. Accordingly, the upper incidence surface 25A assists in setting each of the light distribution images Li at the above-described position by the adjustment of the upper emission surface 26A (see FIGS. 5 to 7).

As illustrated in FIG. 12, the curvature of the lower incidence surface 25B is adjusted such that, with respect to the light from the light source 21 in transverse cross-section, the light (group of rays) passing at a position away from the optical axis La in a radial direction diffuses and also the degree of diffusion of the light (group of rays) passing in the vicinity of the optical axis La in the radial direction is small. Specifically, in transverse cross-section, the lower lens part 32 diffuses the light at a position away from the optical axis La and also focuses the light at a position closer to the optical axis La. Accordingly, the lower incidence surface 25B assists in setting each of the light distribution images Li at the above-described position by the adjustment of the lower emission surface 26B (see FIGS. 8 to 10).

The vehicular lamp 10 is assembled as below with reference to FIG. 2. First, the light source 21 is mounted on the substrate 22 while positioned with respect to the substrate 22, and thus the light source unit 11 is assembled. Subsequently, the respective mounting protrusions 27 of the two mounting parts 24 of the projection lens 12 are fitted into the corresponding mounting holes 22a of the substrate 22 of the light source unit 11 to fix the two mounting parts 24 to the substrate 22. Accordingly, the radiation central axis of the light source 21 of the light source unit 11 conforms with the lens axis of the lens main body part 23 of the projection lens 12 with a predetermined interval, and they serve as the optical axis La in the vehicular lamp 10. In this state, the light source unit 11 and the projection lens 12 are attached to assemble the vehicular lamp 10.

As illustrated in FIG. 1, the vehicular lamp 10 is provided in the lamp chamber with the optical axis La oriented toward the side of the vehicle 1 and inclined with respect to the road surface 2 in the surrounding area of the vehicle 1. The vehicular lamp 10 supplies electric power from the lighting control circuit to the light source 21 from the substrate 22 to turn on and off the light source 21 as appropriate. The light from the light source 21 is projected while the light is controlled by the projection lens 12 to form, on the road surface 2, the irradiation pattern Pi in which, sequentially from the front side along the projection direction Dp, the main instruction symbol Am and the sub instruction symbol Av are positioned side-by-side. The irradiation pattern Pi allows partial illumination of the road surface 2 diagonally on right and left sides in the vicinity of the front end of the vehicle 1. According to the first embodiment, the irradiation pattern Pi is formed in conjunction with for example a turn-signal lamp so as to notify people in the surroundings that the vehicle 1 is turning right or left.

In the irradiation pattern Pi, the main instruction symbol Am is formed by the upper lens part 31 while the main front boundary Bmf is made sharp, and the sub instruction symbol Av is formed by the lower lens part 32 while the sub front boundary Bvf is made sharp. Here, the upper lens part 31 causes each of the light distribution images Li to be positioned side-by-side such that the upper side thereof extends along the main front boundary Bmf and thus the inclination of the upper sides of the light distribution images Li conforms with the inclination of the main front boundary Bmf (see FIGS. 5 to 7). Therefore, with the main instruction symbol Am, the vicinities of the upper sides of the light distribution images Li may be superimposed inside the main front boundary Bmf, and thus the main front boundary Bmf may be made sharp. Conversely, in the lower lens part 32, the inclination of the upper sides of the light distribution images Li by the optical-axis vicinity position 32a has the opposite direction from the inclination of the sub front boundary Bvf, and therefore only one corner part of each of the light distribution images Li is superimposed inside the sub front boundary Bvf (see FIGS. 8 to 10). Accordingly, the main front boundary Bmf of the main instruction symbol Am is brighter and sharper than the sub front boundary Bvf of the sub instruction symbol Av. In particular, in the irradiation pattern Pi, the main front boundary Bmf is formed by the small light distribution images Li from the upper-end vicinity position 31a, and therefore the main front boundary Bmf is properly formed up to the vicinity of the center in the projection transverse direction Dh, which results in the sharp main front boundary Bmf with a more appropriate shape. This is because, with the use of the large light distribution images Li, it is difficult to arrange them along the main front boundary Bmf without falling outside the main instruction symbol Am.

In addition, in the irradiation pattern Pi, according to the settings of the upper lens part 31 and the lower lens part 32, the main instruction symbol Am at a position farthest away from the vehicle 1 on the head side pointed by the arrow is larger than the sub instruction symbol Av. Thus, in the irradiation pattern Pi, the main instruction symbol Am is larger than the sub instruction symbol Av and also the main front boundary Bmf is sharper than the sub front boundary Bvf, and thus the main instruction symbol Am is more emphasized than the sub instruction symbol Av. Thus, the irradiation pattern Pi may make the main instruction symbol Am noticeable and may give the impression that the front side in the projection direction Dp is being pointed. In particular, in the irradiation pattern Pi according to the first embodiment, the main front boundary Bmf is sharp, which is an end part of the main instruction symbol Am on the front side in the projection direction Dp, and therefore it is possible to effectively give the impression that the front side in the projection direction Dp is being pointed.

Next, an operation of the vehicular lamp 10 will be described. The vehicular lamp 10 operates in conjunction with the turn-signal lamp and, when either the right or left turn-signal lamp is turned on, the light source 21 provided on the turned-on side is turned on to form the irradiation pattern Pi on the road surface 2. For example, FIG. 13 illustrates a case where the vehicle 1 traveling straight on the road is about to turn left. In the vehicle 1, when the turn-signal lamp on the left is flashed, the vehicular lamp 10 provided on the front left forms the irradiation pattern Pi on the road surface 2. Accordingly, even when a person in the surrounding area of the vehicle 1 cannot recognize the turn-signal lamp of the vehicle 1, misses it, or has difficulty in seeing it, the person may recognize the irradiation pattern Pi formed on the road surface 2 and thus may know that the vehicle 1 is turning left.

Furthermore, in the vehicle 1, the right and left vehicular lamps 10 operate in conjunction with the turn-signal lamps and therefore, when both the turn-signal lamps are turned on as hazard lamps, the two vehicular lamps 10 on the right and left simultaneously form the irradiation patterns Pi on the road surface 2 (see FIG. 1). Thus, it is possible to ensure that the vehicular lamps 10 cause a person in the surrounding area of the vehicle 1 to recognize that they are turned on as hazard lamps, as compared to a case where only the right and left turn-signal lamps are flashed.

Furthermore, with the vehicular lamp 10, the upper lens part 31 forms the main instruction symbol Am and the lower lens part 32 forms the sub instruction symbol Av with the light from the light source 21 in the projection lens 12. Therefore, the vehicular lamp 10 may reduce the number of parts, simplify assembly, facilitate a size reduction, and reduce manufacturing costs, compared to a vehicular lamp having a conventional configuration to block part of the light from the light source with a slit plate. For the assembly accuracy, there is a need to set an appropriate positional relationship among three, i.e., the light source, the slit plate, and the projection lens, in the vehicular lamp having the conventional configuration, whereas, in the vehicular lamp 10, there is a need to set an appropriate positional relationship between two, i.e., the light source 21 and the projection lens 12. In particular, in the vehicular lamp 10, the two mounting parts 24 of the projection lens 12 are fixed to the substrate 22 of the light source unit 11 and thus the positional relationship between two, i.e., the light source 21 and the projection lens 12, is defined; therefore, the number of parts may be further reduced, and also the positions of both of them may be more appropriate. In addition, the vehicular lamp 10 may reduce the possibility of changes over time as in the case where a filter whose performance changes due to the effect of the use environment is used as a slit plate, and may form the irradiation pattern Pi on the road surface 2 in a stable manner.

The vehicular lamp 10 has the lens main body part 23 separated as the upper lens part 31 and the lower lens part 32 in the up-down direction and has the curvature (surface shape) set for each of the emission surfaces 26 to form the main instruction symbol Am and the sub instruction symbol Av. Therefore, the vehicular lamp 10 may form the irradiation pattern Pi including the two instruction symbols (Am, Av) with a simple configuration including the light source unit 11 and the projection lens 12 without using a new light source. In particular, in the vehicular lamp 10, as the focal length of the upper emission surface 26A is larger than the focal length of the lower emission surface 26B, the main instruction symbol Am and the sub instruction symbol Av, which have different distances and are formed due to the inclination of the optical axis La with respect to the road surface 2, may be properly formed with the light from the single light source unit 11.

In the vehicular lamp 10, as the upper emission surface 26A is displaced further to the front side in the optical axis direction than the lower emission surface 26B in the lens main body part 23, the stepped surface 26C (see FIG. 4) provided therebetween faces downward in the up-down direction. Therefore, in the vehicular lamp 10, even when the light guided into the lens main body part 23 from the light source 21 results in a leakage light that is emitted from the stepped surface 26C or reflected by the stepped surface 26C, the leakage light may be oriented downward in the up-down direction. Accordingly, the vehicular lamp 10 may orient the leakage light further to the back side in the projection direction Dp than the main instruction symbol Am on the road surface 2 so as to prevent the main instruction symbol Am from being blurred by the leakage light.

In the vehicular lamp 10, the light source 21 emits the above-described amber light, and therefore the effect of chromatic aberration in the projection lens 12 may be greatly suppressed. Therefore, the vehicular lamp 10 may form the irradiation pattern Pi having sharper boundaries with the circumferences of the main instruction symbol Am and the sub instruction symbol Av.

The vehicular lamp 10 according to the first embodiment may obtain each of the following operational effects.

The vehicular lamp 10 includes the light source 21 and the projection lens 12 that projects the light from it to form the irradiation pattern Pi. In the vehicular lamp 10, the irradiation pattern Pi includes the main instruction symbol Am formed on the front side in the projection direction Dp and the one or more sub instruction symbols Av formed further on the back side in the projection direction Dp than it, and the main instruction symbol Am is more emphasized than the sub instruction symbol Av. In the vehicular lamp 10, the projection lens 12 includes the upper lens part 31 that forms the main instruction symbol Am and the lower lens part 32 that forms the sub instruction symbol Av. Therefore, in the vehicular lamp 10, with a simple configuration of providing the projection lens 12 in the light source 21, the irradiation pattern Pi including the main instruction symbol Am and the sub instruction symbol Av may be formed on the projection target, and a certain intention may be conveyed to a person in the surrounding area with the irradiation pattern Pi. Furthermore, in the vehicular lamp 10, as the main instruction symbol Am is more emphasized than the sub instruction symbol Av, it is possible to give the impression that the front side in the projection direction Dp is being pointed, and it is possible to ensure that a certain intention (e.g., a right or left turn according to the first embodiment) of the driver is conveyed to a person in the surrounding area.

In the vehicular lamp 10, the incidence surface 25 of the projection lens 12 is a continuous surface, and at least both end parts in the horizontal direction of the upper emission surface 26A in the upper lens part 31 protrude further to the projecting side than both end parts in the horizontal direction of the lower emission surface 26B in the lower lens part 32. Therefore, in the vehicular lamp 10, as the upper emission surface 26A is displaced further to the front side in the optical axis direction than the lower emission surface 26B, the main instruction symbol Am and the sub instruction symbol Av having different distances due to the inclination of the optical axis La with respect to the road surface 2 may be properly formed with the light from the single light source unit 11.

Furthermore, in the vehicular lamp 10, the focal length of the upper lens part 31 is equal to or more than the focal length of the lower lens part 32. Therefore, in the vehicular lamp 10, due to the inclination of the optical axis La with respect to the road surface 2, the main instruction symbol Am, which is located relatively far, and the sub instruction symbol Av, which is located relatively close, may be properly formed with the light from the single light source unit 11.

Furthermore, in the vehicular lamp 10, the main instruction symbol Am is larger than the sub instruction symbol Av. Therefore, the vehicular lamp 10 may emphasize the main instruction symbol Am without having a special optical configuration, which may achieve a simple configuration.

The vehicular lamp 10 collects the light in at least part of the bright-dark boundary Bm of the main instruction symbol Am. Therefore, the vehicular lamp 10 may emphasize the main instruction symbol Am by simply adjusting the curvature of the upper lens part 31, which may achieve a simple configuration.

In the vehicular lamp 10, the upper lens part 31 collects the light from the light source 21 in the vicinity of the optical axis and also collects the light at the main front boundary Bmf for the main instruction symbol Am, while the lower lens part 32 diffuses the light from the light source 21 in the horizontal direction (the projection transverse direction Dh) for the sub instruction symbol Av. Thus, the vehicular lamp 10 simply adjusts the curvatures of the upper emission surface 26A and the upper incidence surface 25A in the upper lens part 31 and the curvatures of the lower emission surface 26B and the lower incidence surface 25B in the lower lens part 32 as appropriate so as to form the main instruction symbol Am having the emphasized main front boundary Bmf and the sub instruction symbol Av having uniform brightness.

Therefore, the vehicular lamp 10 according to the first embodiment, which is a vehicular lamp according to the present disclosure, may form the irradiation pattern Pi with which a certain intention may be conveyed to a person in the surrounding area while efficiently using the light from the light source 21 and reducing the number of parts.

### Second Embodiment

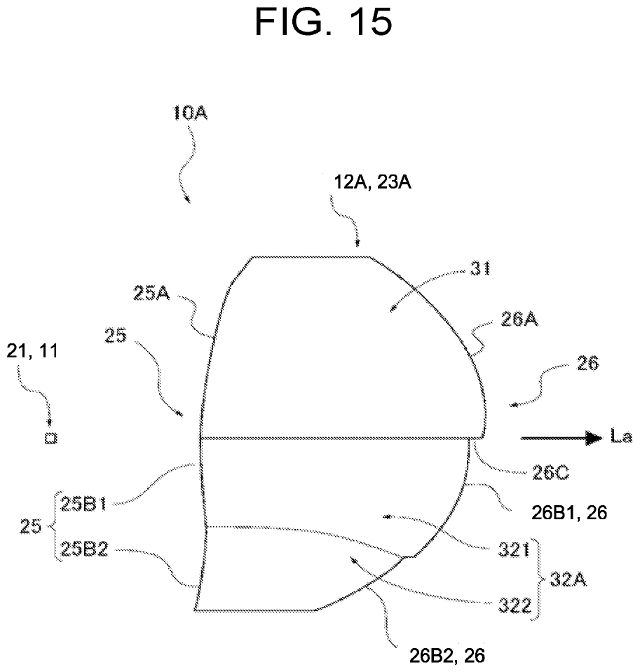

Next, a vehicular lamp 10A according to a second embodiment, which is an embodiment according to the present disclosure, will be described by using FIGS. 14 and 15. Changes have been made to the vehicular lamp 10A in an irradiation pattern PiA which is different from the irradiation pattern Pi formed by the vehicular lamp 10 according to the first embodiment and accordingly the configuration of a projection lens 12A. The vehicular lamp 10A is the same as the vehicular lamp 10 according to the first embodiment in the basic concept and configuration, and therefore the part having the same configuration is denoted by the same reference numeral, and detailed descriptions are omitted.

As illustrated in FIG. 14, in the irradiation pattern PiA according to the second embodiment, the sub instruction symbol Av includes two signals, i.e., a first sub instruction symbol Av1 and a second sub instruction symbol Av2. The first sub instruction symbol Av1 and the second sub instruction symbol Av2 are continuous to the main instruction symbol Am and are positioned side-by-side in the projection direction Dp and, like the main instruction symbol Am and the sub instruction symbol Av according to the first embodiment, resemble the arrow pointing to the front side in the projection direction Dp. The first sub instruction symbol Av1 and the second sub instruction symbol Av2 are obtained by joining two straight lines that protrude to the front side in the projection direction Dp, bend, and also connect to each other at the central position in the projection transverse direction Dh according to the second embodiment. The first sub instruction symbol Av1 is more emphasized than the second sub instruction symbol Av2 but less emphasized than the main instruction symbol Am. The first sub instruction symbol Av1 according to the second embodiment is smaller than the main instruction symbol Am and is larger than the second sub instruction symbol Av2.

Furthermore, as illustrated in FIG. 15, in the vehicular lamp 10A according to the second embodiment, in order to form the first sub instruction symbol Av1 and the second sub instruction symbol Av2 as the sub instruction symbol Av, a lower lens part 32A of the projection lens 12A includes a first lower lens part 321 and a second lower lens part 322 that are positioned side-by-side in the up-down direction. The first lower lens part 321 forms the first sub instruction symbol Av1, and the second lower lens part 322 forms the second sub instruction symbol Av2. In the projection lens 12A, the incidence surface 25 is a continuous surface, that is, a continuous surface from the upper incidence surface 25A of the upper lens part 31 to the lower incidence surface 25B (a first lower incidence surface 25B1 of the first lower lens part 321, a second lower incidence surface 25B2 of the second lower lens part 322) of the lower lens part 32A.

In the projection lens 12A, the focal length of the first lower lens part 321 is larger than the focal length of the second lower lens part 322. This allows the lens main body part 23 to properly project, on the projection target (the road surface 2), the first sub instruction symbol Av1 at a position close to the main instruction symbol Am and properly project the second sub instruction symbol Av2 at the closest position with the light from the single light source unit 11 (the light source 21). In the lower lens part 32A, a first lower emission surface 26B1, which is the emission surface 26 of the first lower lens part 321, is displaced further to the front side in the optical axis direction than a second lower emission surface 26B2, which is the emission surface 26 of the second lower lens part 322, and thus the focal lengths of the upper lens part 31 and the lower lens part 32 are set.

Accordingly, in the projection lens 12A, the emission surface 26 is gradually displaced to the back side in the optical axis direction, sequentially starting from the upper emission surface 26A, the first lower emission surface 26B1, and then the second lower emission surface 26B2, from the front side in the optical axis direction. The first lower emission surface 26B1 and the second lower emission surface 26B2 are optically set by gradually changing the curvature to form the corresponding sub instruction symbols (Av1, Av2) and thus each have a single smooth surface without steps. According to this setting method, in the same manner as the lower emission surface 26B according to the first embodiment, the light distribution images Li are formed on the screen in accordance with the corresponding sub instruction symbols (Av1, Av2), and thus sub front boundaries (Bvf1, Bvf2) are made sharp and up to both side ends of the sub instruction symbols (Av1, Av2) in the projection transverse direction Dh are illuminated. This setting may be made in the same manner as the lower emission surface 26B (see FIGS. 8 to 10) according to the first embodiment based on the assumption that the first lower emission surface 26B1 corresponds to the first sub instruction symbol Av1 and the second lower emission surface 26B2 corresponds to the second sub instruction symbol Av2, and therefore detailed descriptions are omitted.

Here, in the lens main body part 23A, the row of the light distribution images Li by the light passing through the upper lens part 31 tends to form an arc protruding to the front side in the projection direction Dp as described above, and the row of the light distribution images Li by the light passing through the lower lens part 32A tends to form an arc protruding to the back side in the projection direction Dp. Meanwhile, in the irradiation pattern PiA, the main instruction symbol Am and the two sub instruction symbols (Av1, Av2) together draw the arrow with the straight lines protruding to the front side in the projection direction Dp and bending at the central position in the projection transverse direction Dh. Therefore, in the upper lens part 31, the degree of curvature of the arc is adjusted such that the row of the formed light distribution images Li conforms with the shape of the main instruction symbol Am, and thus the formation of the main instruction symbol Am with the light distribution images Li in the above-described positional relationship is assisted. Similarly, in the lower lens part 32A, the curving direction of the arc is reversed so as to protrude to the front side and the degree of curvature of the arc is adjusted such that the row of the formed light distribution images Li conforms with the shape of the corresponding sub instruction symbol (Av1, Av2), and thus the formation of the corresponding sub instruction symbol (Av1, Av2) with each of the light distribution images Li at an appropriate position is assisted.

As illustrated in FIG. 15, as in the first embodiment, the upper incidence surface 25A is a convex surface in longitudinal cross-section, i.e., a curved surface protruding toward the light source 21. This is because the upper incidence surface 25A may reduce distortion in each of the light distribution images Li and may reduce the size of each of the light distribution images Li so as to reduce the size of the row, in which the light distribution images Li are arranged, in the projection direction Dp, as compared to the case where it is a flat or concave surface. Thus, the upper incidence surface 25A may collect the light at the main front boundary Bmf more properly for sharpness and also may illuminate up to both side ends in the projection transverse direction Dh so as to form the main instruction symbol Am.

Furthermore, the range from the first lower incidence surface 25B1 to the second lower incidence surface 25B2 is a concave surface in longitudinal cross-section, i.e., a curved surface protruding toward the opposite side of the light source 21. This is because the range from the first lower incidence surface 25B1 to the second lower incidence surface 25B2 may increase the size of each of the light distribution images Li and increase the size of the row in which the light distribution images Li are arranged in the projection direction Dp, as compared to the case where it is a flat or convex surface. Thus, with the first lower lens part 321 and the second lower lens part 322, the first sub instruction symbol Av1 is formed with the sharp first sub front boundary Bvf1, and the second sub instruction symbol Av2 is formed with the sharp second sub front boundary Bvf2.

The vehicular lamp 10A according to the second embodiment has each operational effect below. As the vehicular lamp 10A basically has the same configuration as that of the vehicular lamp 10 according to the first embodiment, the same effect as that in the first embodiment may be obtained.

In addition, in the vehicular lamp 10A, the incidence surface 25 includes the upper incidence surface 25A corresponding to the upper lens part 31 and the lower incidence surface 25B (the first lower incidence surface 25B1, the second lower incidence surface 25B2) corresponding to the lower lens part 32A, the upper incidence surface 25A in longitudinal cross-section is a convex surface, and the lower incidence surface 25B in longitudinal cross-section is a concave surface. Thus, the vehicular lamp 10A may properly form the main instruction symbol Am, the first sub instruction symbol Av1, and the second sub instruction symbol Av2 with a simple configuration of adjusting the curvature of the incidence surface 25.

In addition, in the vehicular lamp 10A, the projection lens 12A forms the main instruction symbol Am by using the light distribution images Li projected by the upper lens part 31, forms the first sub instruction symbol Av1 by using the light distribution images Li projected by the first lower lens part 321 of the lower lens part 32A, and forms the second sub instruction symbol Av2 by using the light distribution images Li projected by the second lower lens part 322 of the lower lens part 32A. Thus, the vehicular lamp 10A individually forms the main instruction symbol Am, the first sub instruction symbol Av1, and the second sub instruction symbol Av2 in the three areas obtained by further dividing the projection lens 12A in the up-down direction, and thus it is possible to form the irradiation pattern PiA, with which a certain intention of the driver may be conveyed to a person in the surrounding area, with a simple configuration including the light source unit 11 and the projection lens 12A.

Therefore, the vehicular lamp 10A according to the second embodiment, which is a vehicular lamp according to the present disclosure, may form the irradiation pattern PiA with which a certain intention may be conveyed to a person in the surrounding area while efficiently using the light from the light source 21 and reducing the number of parts.

The vehicular lamp according to the present disclosure has been described above based on the embodiments, but specific configurations are not limited to the embodiments, and design modifications, additions, and the like, are allowable without departing from the gist of the invention according to the claims in the scope of claims.

Furthermore, according to the embodiments, the irradiation patterns Pi, PiA are formed by using the two or more instruction symbols (Am, Av (Av1, Av2)) connecting the two straight lines that protrudes to the front side in the projection direction Dp, bend, and connect to each other at the central position in the projection transverse direction Dh on the road surface 2. However, for the irradiation patterns Pi, PiA, the shape of each instruction symbol may be set as appropriate to resemble an arrow or other shapes as long as it points the front side in the projection direction Dp, and not limited to the configurations according to the embodiments.

Furthermore, according to the embodiments, in the irradiation patterns Pi, PiA, the main instruction symbol Am is larger and sharper than the sub instruction symbol Av to emphasize the main instruction symbol Am. However, the main instruction symbol Am may be emphasized by making it more noticeable than the sub instruction symbol Av, including a difference in size and the degree of sharpness, and not limited to the configurations according to the embodiments. Moreover, the main instruction symbol Am may have the same degree of emphasis as that of the sub instruction symbol Av, i.e., may have the same size and the same sharpness as that of the sub instruction symbol Av, and not limited to the configurations according to the embodiments.

Furthermore, according to each of the embodiments, the main front boundary Bmf of the main instruction symbol Am is sharp and the sub instruction symbol Av has the uniform brightness to thus set the degree of sharpness for the main instruction symbol Am and the sub instruction symbol Av. However, for the setting of the degree of sharpness, the other bright-dark boundary Bv may be sharp or a difference in the entire brightness may be used as long as the main instruction symbol Am is more emphasized than the sub instruction symbol Av, and not limited to the configurations according to the embodiments.

According to each of the embodiments, the focal length of the upper lens part 31 is larger than the focal length of the lower lens part 32 (including the first lower lens part 321 and the second lower lens part 322 according to the second embodiment). However, the focal lengths of the upper lens part 31 and the lower lens part 32 may be the same as long as at least both end parts in the horizontal direction of the upper emission surface 26A allowing emission of the light from the light source 21 in the upper lens part 31 protrudes further to the projecting side than both end parts in the horizontal direction of the lower emission surface 26B allowing emission of the light from the light source 21 in the lower lens part 32, and not limited to the configurations according to the embodiments.

According to the embodiments, the irradiation pattern Pi is formed with the main instruction symbol Am and the sub instruction symbol Av, or the irradiation pattern PiA is formed with the main instruction symbol Am, the first sub instruction symbol Av1, and the second sub instruction symbol Av2. However, the number of the sub instruction symbols Av may be set as appropriate as long as the upper lens part 31 forms the main instruction symbol Am and the lower lens part 32 forms the one or more sub instruction symbols Av, and not limited to the configurations according to the embodiments.

The upper incidence surface 25A and the lower incidence surface 25B are convex surfaces in the projection lens 12 according to the first embodiment, and the upper incidence surface 25A is a convex surface and the lower incidence surface 25B is a concave surface in the projection lens 12A according to the second embodiment. However, the upper incidence surface 25A and the lower incidence surface 25B may have either a convex surface or a concave surface, and not limited to the configurations according to the embodiments.

### DESCRIPTION OF REFERENCE NUMERALS

10 Vehicular lamp
12 Projection lens
21 Light source
25 Incidence surface
25A Upper incidence surface
25B Lower incidence surface
26A Upper emission surface
26B Lower emission surface
31 Upper lens part
32 Lower lens part
Am Main instruction symbol
Av, Av1, Av2 Sub instruction symbol
Bm Bright-dark boundary
Dp Projection direction
Pi Irradiation pattern

1. A vehicular lamp comprising:
a light source; and
a projection lens that projects a light emitted from the light source to form an irradiation pattern, wherein
the irradiation pattern includes
a main instruction symbol formed on a front side in a projection direction, and
one or more sub instruction symbols formed further on a back side than the main instruction symbol in the projection direction,
the main instruction symbol is more emphasized than the sub instruction symbols, and
the projection lens includes
an upper lens part that forms the main instruction symbol, and
a lower lens part that forms the sub instruction symbols.

2. The vehicular lamp according to claim 1, wherein
the projection lens has a continuous surface as an incidence surface allowing incidence of light from the light source, and
at least both end parts in a horizontal direction of an upper emission surface allowing emission of light from the light source in the upper lens part protrude further to a projecting side than both end parts in the horizontal direction of a lower emission surface allowing emission of light from the light source in the lower lens part.

3. The vehicular lamp according to claim 2, wherein a focal length of the upper lens part is equal to or more than a focal length of the lower lens part.

4. The vehicular lamp according to claim 1, wherein the main instruction symbol is larger than the sub instruction symbols.

5. The vehicular lamp according to claim 1, wherein, in the main instruction symbol, light is collected in at least part of a bright-dark boundary.

6. The vehicular lamp according to claim 1, wherein
in the main instruction symbol, the upper lens part collects light from the light source in a vicinity of an optical axis and also collects the light at a main front boundary of a bright-dark boundary on the front side in the projection direction, and
in the sub instruction symbols, the lower lens part diffuses the light from the light source in a horizontal direction.

7. The vehicular lamp according to claim 6, wherein
an incidence surface allowing incidence of the light from the light source in the projection lens includes
an upper incidence surface corresponding to the upper lens part, and
a lower incidence surface corresponding to the lower lens part,
the upper incidence surface is a convex surface in longitudinal cross-section, and
the lower incidence surface is a concave surface in longitudinal cross-section.
